(19) United States
(12) Patent Application Publication
(10) Pub. No.: US 2007/0214415 A1
(43) Pub. Date: Sep. 13, 2007

(54) Systems and Methods for Logo Design

(76) Inventor: John M. Williams, Carlsbad, CA (US)

Correspondence Address: KOESTNER BERTANI LLP, 2192 Martin St., Suite 150, Irvine, CA, 92612, US

(21) Appl. No.: 11/750,241

(22) Filed: May 17, 2007

Related U.S. Application Data
(63) Continuation-in-part of application No. 11/013,239, filed on Dec. 14, 2004.

(51) Int. Cl. G06F 3/00

(52) U.S. Cl. 715/700

(57) ABSTRACT

Systems and methods for interactively designing a logo present a list of desired characteristics to be conveyed by the logo, and allows the user to select from among the desired characteristics, such as image and/or type of industry. A group of symbols are presented to the user based on the desired characteristic(s), and the user is allowed to select at least one of the symbols to be used in the logo. Selectable options are presented to allow the user to interactively change one or more features of the logo on a display, as well as to add text, color, position, and relative size of the text to the symbol. The symbols can be categorized in a database that is searchable according to various search criteria, categories, and sub-categories selectable by the user.

### CROSS-REFERENCE TO RELATED APPLICATION

This application is a continuation-in-part of U.S. patent application Ser. No. 11/013,239 entitled “Systems and Methods for Logo Design”, filed Dec. 14, 2004.

### BACKGROUND

Prior to computers and the Internet, a user, such as a business owner or employee of an organization, could either create their own logo, or engage a designer to create one or more candidate logos from among which to choose. The user could also provide feedback to the designer to make changes to one or more of the candidate logos before choosing. With the advent of computers and the Internet, the user can seek help with the logo design process, such as finding a graphic designer, online. The designer creates one or more logos based on information provided by the user, and the user's involvement is limited to providing feedback.

In one online method, the user inputs criteria for a logo using a computer keyboard, wherein the criteria might include whether the user prefers a “select” (premier level) or “basic” designer to work on your logo. A “select” level designer has verified credentials, typically verified by a company such as U.S. Search or Square Trade. “Select” designers must also agree to abide by certain performance standards, which require providers to offer detailed and accurate bids. The winning bidder then creates the logo for the user. As may be seen, this is not a logo creation tool whereby the user controls the appearance of any and all elements of the logo during a creative process.

Another online method allows the user to provide input regarding their concept for a logo using a short online form. One or more designers produce concepts based on the information provided by the user. The user chooses one of the logos from the designs, and can then work with a designer to make a limited number of final revisions to the logo. Once again, the user cannot control the appearance of any and all elements of the logo during the creative process, or make as many changes as necessary to achieve a logo that conveys the desired image for their organization.

Other online systems charge a flat rate fee for a design session. The user accesses a secure online order form, completes a design questionnaire, and places an order via an online payment system. If the system accepts the order, the user is provided with a login name and password, which allows entry to a customer viewing center. The candidate logo is generated and made available for viewing by the user. The user can interact with the designer/artist by making comments and selections in the customer viewing center on a comments/approval form. The comments/approval form allows the user to approve, request a change, or ask for additional logo concepts. After submission of the form and after the artists complete the request, the user receives an e-mail advising the user to return to the customer viewing center to see the new logo. Once a logo is approved, the logo is provided in multiple formats for the customer to download (for example, IBM, Macintosh™, AI, EPS, TIFF, JPEG, and GIF). As may be seen, the user cannot control the appearance of any and all elements of the logo during the creative process, or make as many changes as necessary to achieve a logo that conveys the desired image for their organization.

Another fee-for-service website allows access to stock symbols, which may or may not be original, high-quality symbols. The website advertises “add your organization name or other text and you have a professional design.”However, “customization” (names, layout, font, colors) are performed by a designer who is not online. The site allows a user to search stock design catalogs. The user can access links to a limited number of other websites to search for an actual symbol. The user can request changes to the colors and type face, and add a text string to the symbol. Once again, such a fee-for-service website does not provide a logo creation tool whereby the user controls the relationship of look (or image, or perception) of any and all elements of the logo during a creative process. Moreover, the logos are designed for embroidering, not for use on business materials such as business cards, letterhead, trade brochures, and the like. The user is inconvenienced in having to leave the main web site and access other websites to search for symbols, which is cumbersome, unclear, and still requires designer input.

Some known systems allow a user to select, modify and superimpose one image on another. A client computer system accesses a centralized server to construct and preview a composite image of two or more images. The server includes data representative of the images, and generates from the inputted set of images a corresponding set of templates. Each template bears a corresponding one of the set of the first images. Next, the set of templates is loaded into the first library. Then, the set of second images are loaded into the second library. The first image represents a promotional product while the second image represents a logo, and the composite image is the logo superimposed on the promotional product. Such a system provides an online promotional merchandise store, but does not provide a logo creation tool whereby the user controls the relationship of look (or image, or perception) to any and all elements of the logo during a creative process.

In other systems, a user selects a graphic template from a library of graphic templates. The graphic template for a graphic object contains both predefined graphic parameters and user-defined graphic parameters. A user is prompted to specify the user-defined graphic parameters. Once both the user defined and predefined graphic parameters are set, the vector graphic instructions from the now completed graphic template are rendered to produce a bitmap graphic object that is anti-aliased against the background. Such a system is particularly useful for producing customized graphic objects for use on Internet web pages. However, this system does not provide a tool whereby the user controls the relationship of look (or image, or perception) to any and all elements of the logo during a creative process.

Despite the best efforts of the present state of the art Internet fee-for-service based logo design methods, none of the known logo design methods are entirely satisfactory from the standpoint of the user.

### SUMMARY

Systems and methods are disclosed herein that provide the ability to create a logo and other corporate identity materials quickly and easily. The client can select an image, industry, and/or other characteristic to be conveyed by the materials. The term “image” relates to an impression to be created in the mind of a person viewing the logo. Various embodiments of the system and method allow the client to change font, size, color, layout, and/or other features of the components of the logo, as well as allow reorienting the font characters with one or more chosen symbols. In addition, all or portions of the logo can be re-sized, moved, rotated, transposed, and otherwise manipulated by the client based on the desired impression to be conveyed by the logo.

In some embodiments, a method of creating a logo includes receiving information regarding a desired image to be conveyed by the logo; presenting images of symbols that convey the desired image on a user interface; allowing the user to select at least one of the symbols to be included in the logo; and presenting selectable options on the user interface to allow the user to interactively modify at least a portion of the logo.

In other embodiments, a method of designing a logo includes accessing a computerized database of symbols, and displaying the symbols from the database on a user interface. The symbols presented can be based on selection and/or search criteria entered by a user. Once the user selects one of the symbols to be included in the logo, selectable options can be presented on the user interface to allow the user to interactively modify at least a portion of the logo.

In still other embodiments, a computer product for designing a logo includes logic instructions operable to allow the user to select a desired characteristic, such as industry and/or a desired image, to be conveyed by the logo. The symbols presented to the user are based on the selected characteristic. The user can select at least one of the symbols to be used in the logo.

In further embodiments, an apparatus includes means for allowing the user to select as least one of an industry associated with an organization and an image to be conveyed by a logo; means for searching a database of logo symbols based on the selected industry or image; means for presenting the logo symbols found while searching the database; means for allowing the user to select at least one of the logo symbols as part of the logo; and means for allowing the user to interactively change characteristics of the logo.

Further embodiments of a system for designing a logo include computer executable instructions operable to: present at least one of: a list of desired characteristics to be represented by the logo; allow the user to select at least one of the desired characteristics; present symbols based on at least one of the desired characteristics; and allow the user to select at least one of the symbols to be used in the logo.

In some of the embodiments, the layout and color of selected symbol and/or font may also be influenced by a selected characteristic for which the logo is being designed. A user can select an option for help in determining a selection for the characteristic that would be appropriate for the logo.

Aspects of other embodiments can include resetting the look or image, the symbol, the font, the industry, the color, the layout, or any combination thereof prior to the final selection of the logo. For example, the text and symbol may be moved from one relative position to a second relative position, a symbol may be transposed in mirror image, the symbol and/or the font may be scaled up or scaled down in size. Further, the symbol and/or the font may be rotated on a display, and moved from one location to another on the display.

In further embodiments, once a logo design is selected, the user can select options to create other corporate identity materials such as brochures, stationery, business cards, business forms, promotional items, advertisements, websites, postcards, credit cards, bank checks, and other suitable materials. The user can enter additional information to be included on the materials, and/or select from a number of predesigned templates for the materials. In still other embodiments, the user can customize the templates, or create their own design for the materials.

The foregoing has outlined rather broadly some of the features and technical advantages of embodiments disclosed herein so that those skilled in the art may better understand the detailed description of embodiments that follows.

### BRIEF DESCRIPTION OF THE DRAWINGS

A more complete understanding of the various methods and apparatuses disclosed herein may be had by reference to the following detailed description when taken in conjunction with the accompanying drawings, wherein:

FIG. 1 is a schematic representation of processes that can be included in an embodiment of a method for designing a logo.

FIGS. 2A-K represent embodiments of a user interface that can be utilized during the processes of designing a logo.

FIGS. 2M-2S represent embodiments of a user interface that can be utilized to create other corporate identity materials based on a logo selected by the user.

FIGS. 3A-3P illustrates embodiments of a user interface for determining an image to select for designing a logo.

FIG. 4A is a flowchart of an embodiment of a method for developing logos in accordance with the present invention.

FIG. 4B is a flowchart of an embodiment of a method for converting portions of a logo from Flash to EPS file format to deliver the logo to the user.

FIG. 5 shows an embodiment of a system that can be utilized to implement one or more of the processes of FIG. 1 for designing a logo.

### DETAILED DESCRIPTION

The following description is provided to enable any person skilled in the art to make and use various embodiments of the invention, and sets forth the best modes contemplated by the inventor of carrying out the various embodiments disclosed.

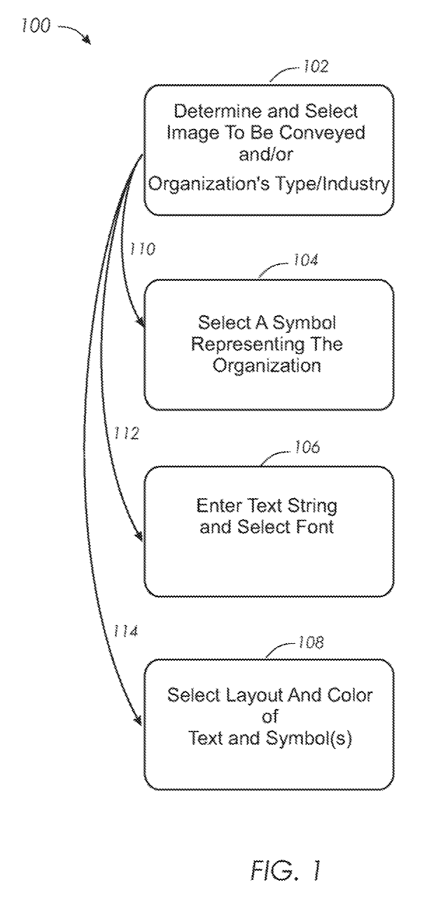

Referring now to the figures, FIG. 1 illustrates an embodiment of a process 100 for designing a logo. In some embodiments, a look or image for the logo can be selected at 102. The term “image” as related to logo design(s) refers to an impression or feeling to be created in the mind of a person viewing the logo. The user may also select a type or an industry for the organization for which the logo is being created at 102. One or more symbols can be presented for selection by the user at 104. The symbol is typically based on the image and/or the organization's type or industry. Other characteristics in addition to, or instead of, image and industry, can be used to determine which symbols to present to the user. Additionally, options can be included to allow the user to provide their own symbol for use in the logo design process. The user can further enter a text string, select a font at 106, and select layout and color at 108 for both the symbol and the text string.

Curved arrows 122, 124, and optionally 126, indicate that the look or image and/or the type/industry selected at 102, can influence the selection of graphic symbols, fonts, layouts, and colors available for selection by the user at 104, 106, and 108, respectively. The ability to filter and tailor the appearance of components of a logo based on the desired image, organization type, and/or industry selected by the user is what is referred to herein as “image-driven” logo creation. Image driven logo creation enables users to interactively design and modify candidate logos without requiring input from a professional designer.

The desired look or image can distinguish the logo from other logos in a customer or user field of endeavor. The desired image may be selected from a group of categories, such as High-tech, Bold, Flair, as well as any other categories that are capable of conveying a desired impression.

In addition to selecting a desired look or image for the logo, the user may also select an industry with which the organization associated and/or the type of organization to be conveyed with the logo. A particular symbol may be chosen which either compliments the desired look or image, or perhaps accentuates the image to be conveyed. For example, if a High-tech perception is desired, the symbol may have sharp features rather than relatively soft features such as might appear in a Flair logo. For example, the base symbol may pertain to the same subject, for example an eagle, but the “High-tech eagle” will typically have a different appearance compared to a “Flair eagle.”

Logo symbols can typically be selected from general categories such as animals, musical instruments, fictitious characters such as griffins and other mascots, fruits, vegetables, as well as specific categories related to specific industries or types of organizations. Logo symbols may be natural or abstract symbols. An example of a natural symbol might be a fish, whereas an example of an abstract symbol might be a geometric design such as concentric circles. Other suitable categories can be utilized.

The type of any selected font may be selected from among a group of suitable fonts, such as, for example, Times New Roman, Arial Tahoma, Courier, Garamond, Andale Mono, BinnerD, Century Schoolbook, Bookman Old Style, Century Gothic, Universal Gilbert, and the like.

Layout of the font and the symbols, and their relative sizes, may be adjusted by moving either the font or the symbols, or both, on the viewing area of a display device. For example, the chosen symbol might be moved left or right or up or down or diagonally across the viewing area, flipped to a mirror image, or simply rotated clockwise or counterclockwise. In some systems, the user may be able to adjust the view aspect, and add effects, such as shadows. Additionally, three-dimensional symbols can be provided, with facilities that allow the user to manipulate the symbols in three dimensions.

Colors may be selected for the symbol and/or the font, and once colors are selected, the user has the option of changing shades or complete color tones within the symbol or font or completely starting over with a new symbol, or indeed a completely new look or image for the symbol and/or font.

Once the user is satisfied with the logo design, the user can save and submit the logo for delivery. Alternatively, the user may return to any previous phase of process 100 at any time. The user can edit the logo design, or “start over”, beginning with a new look or image. Additionally, the user may be issued a password and/or other user identification, allowing the user to save a logo at any stage of the design process, exit, and return at a later time. The user can save one or more candidate logos for later editing and final selection. A reset feature can be provided to allow the user to erase all modifications to a candidate logo that have not been saved.

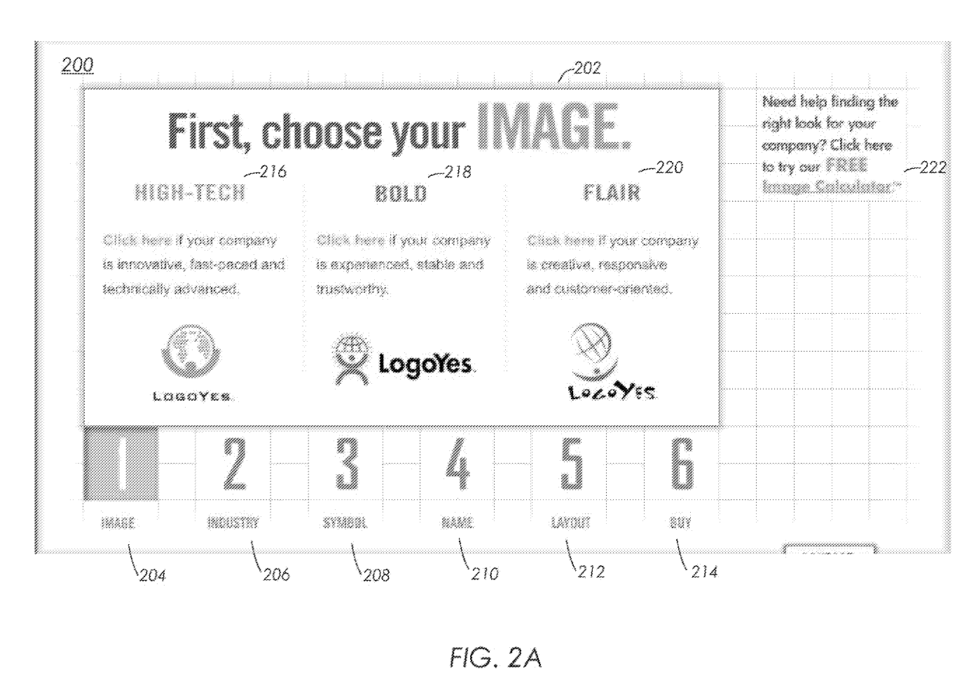

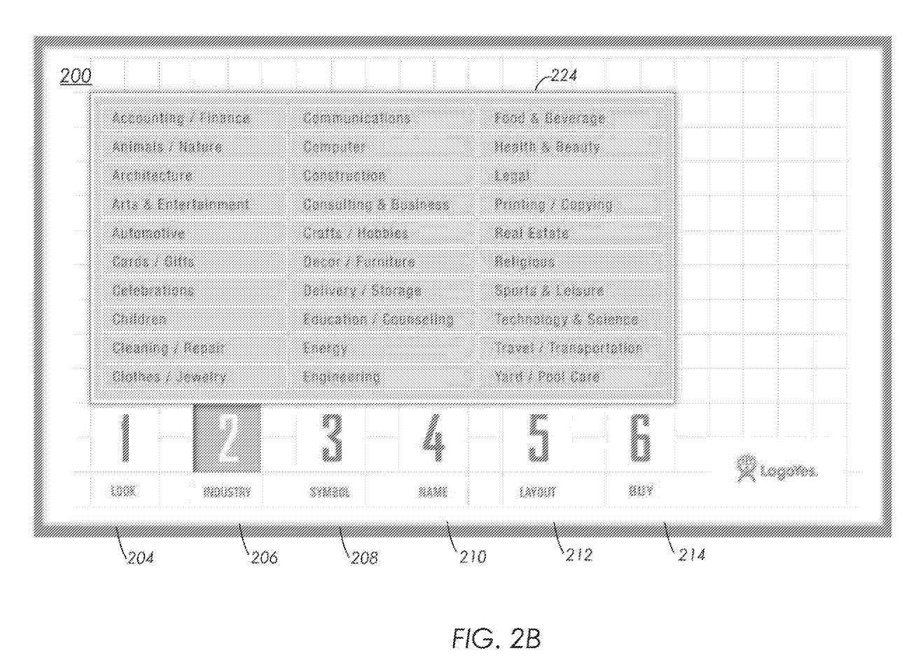

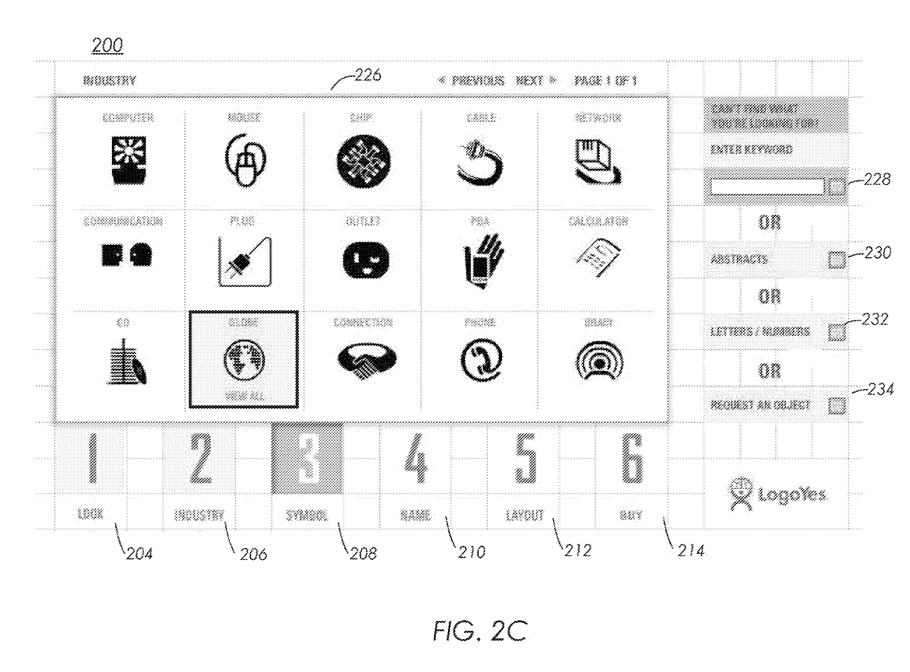

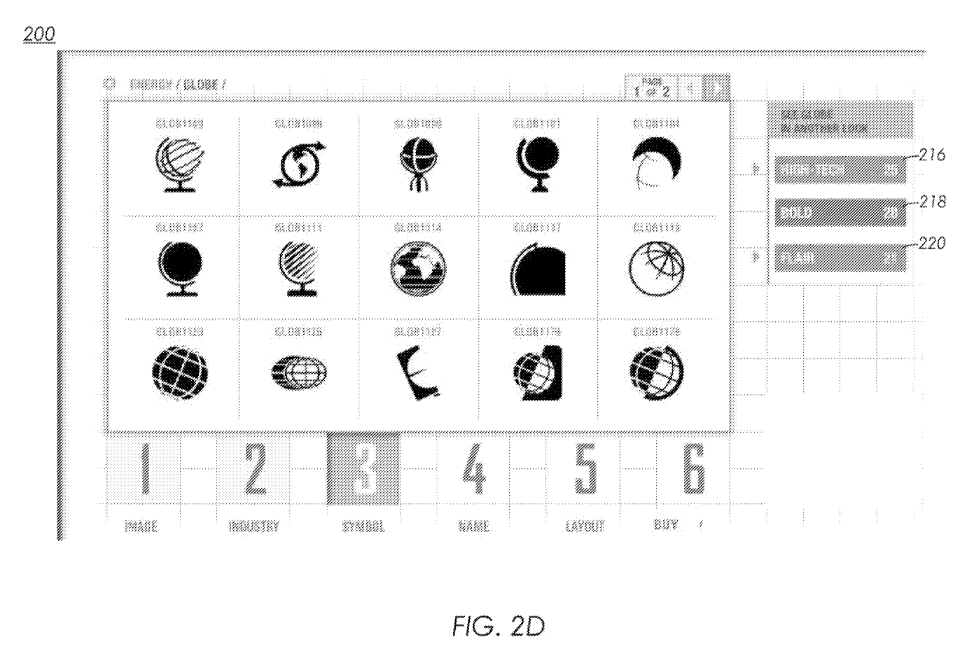

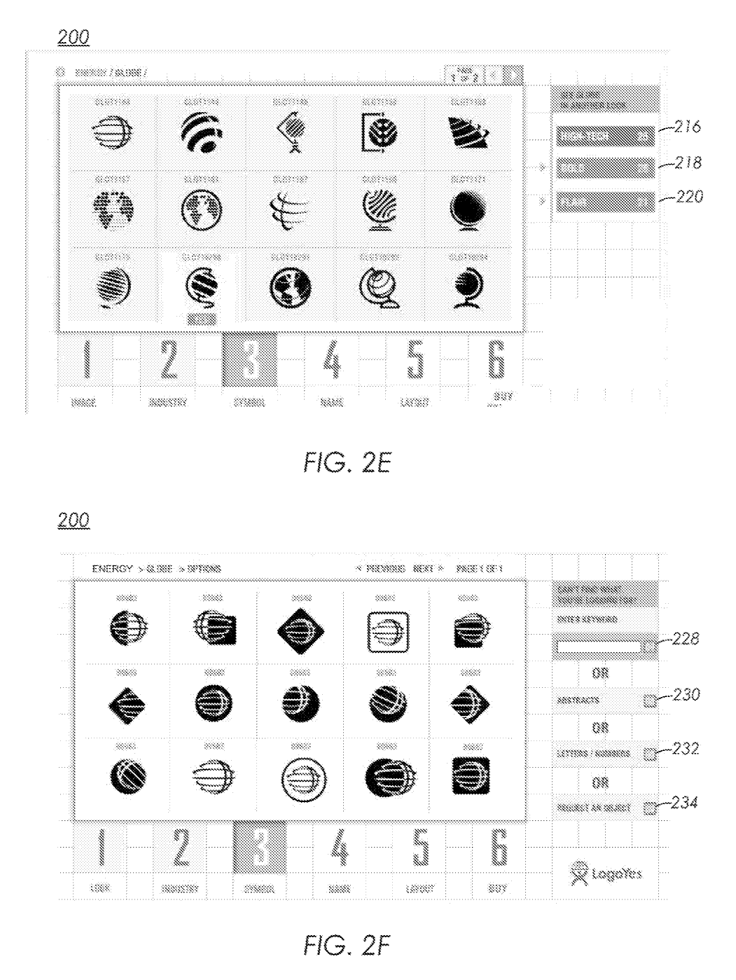

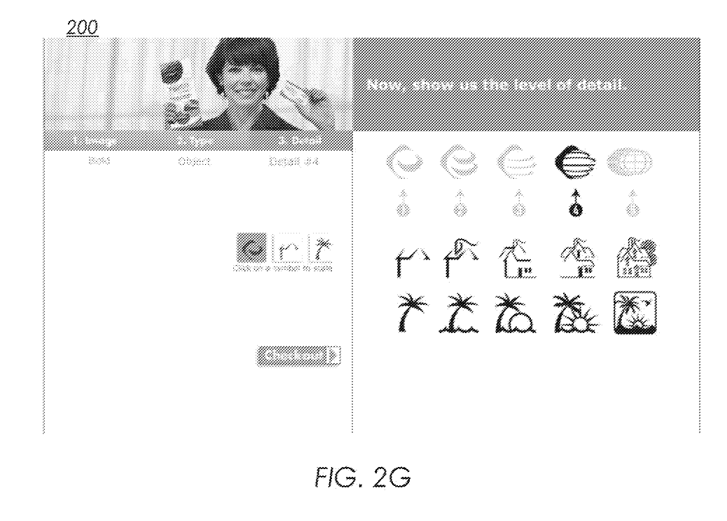

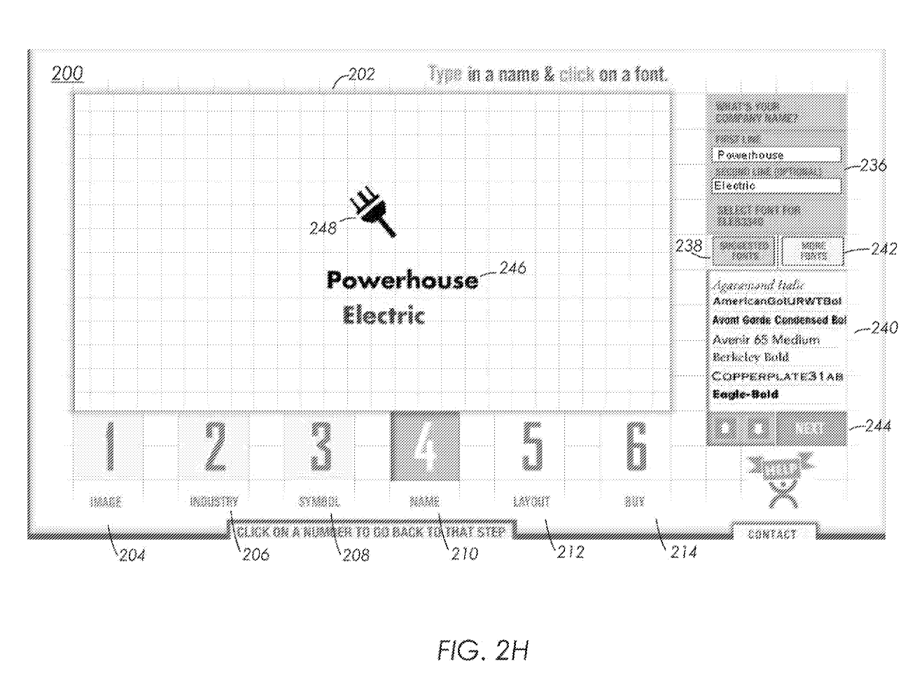

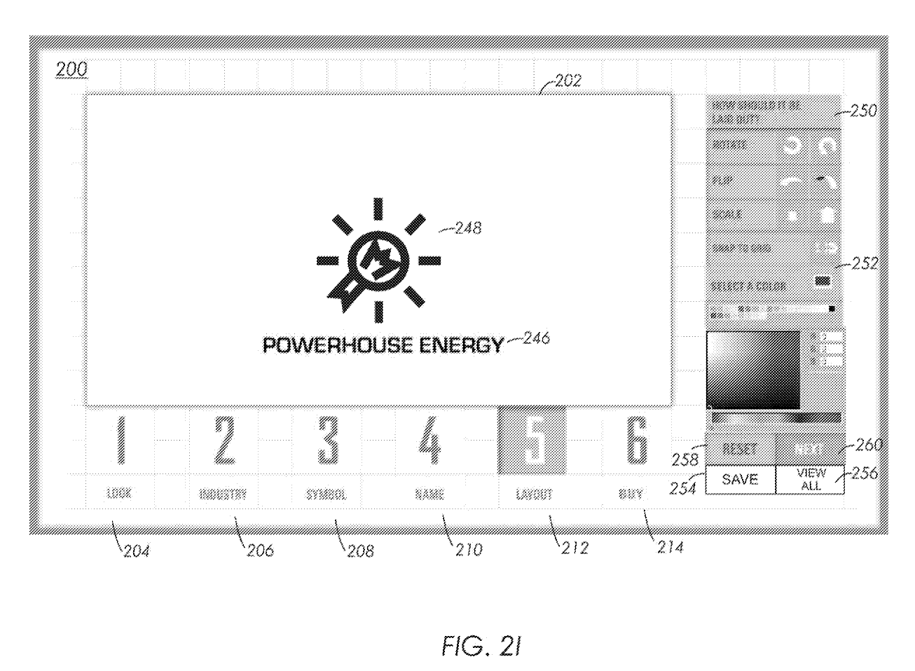

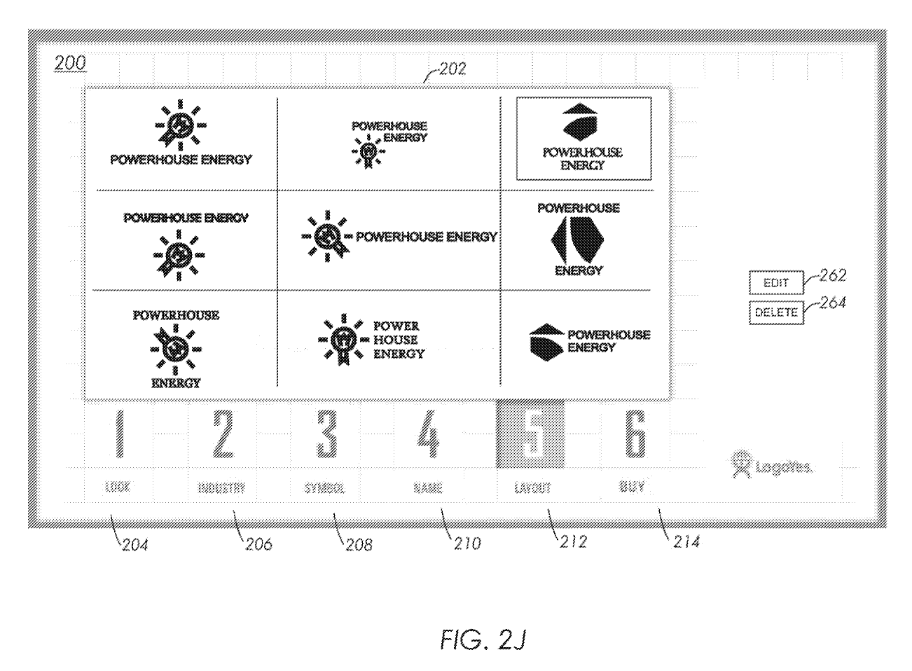

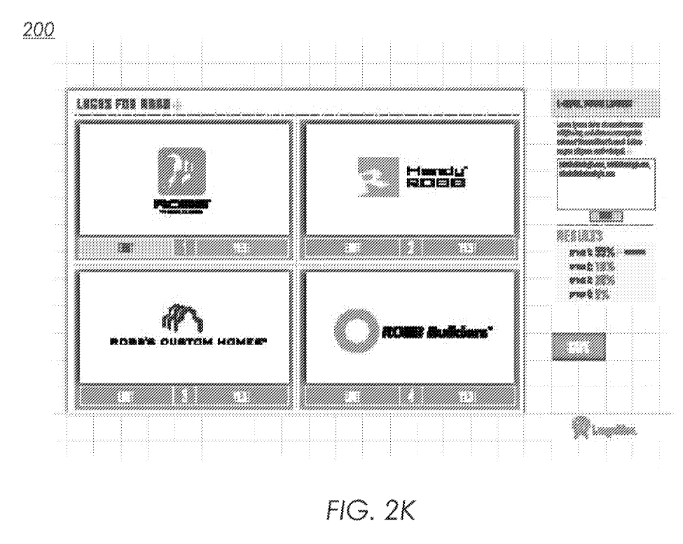

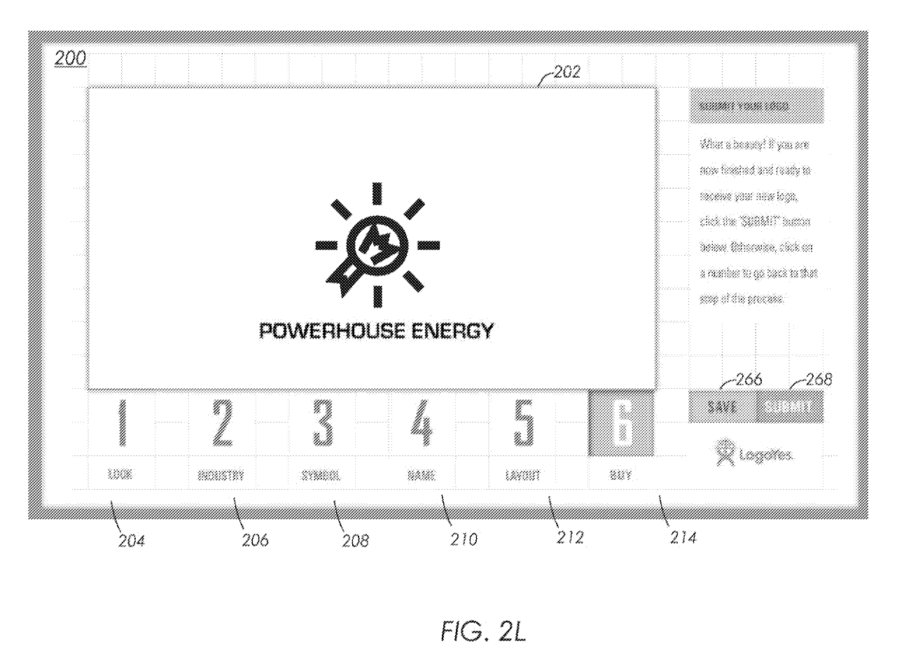

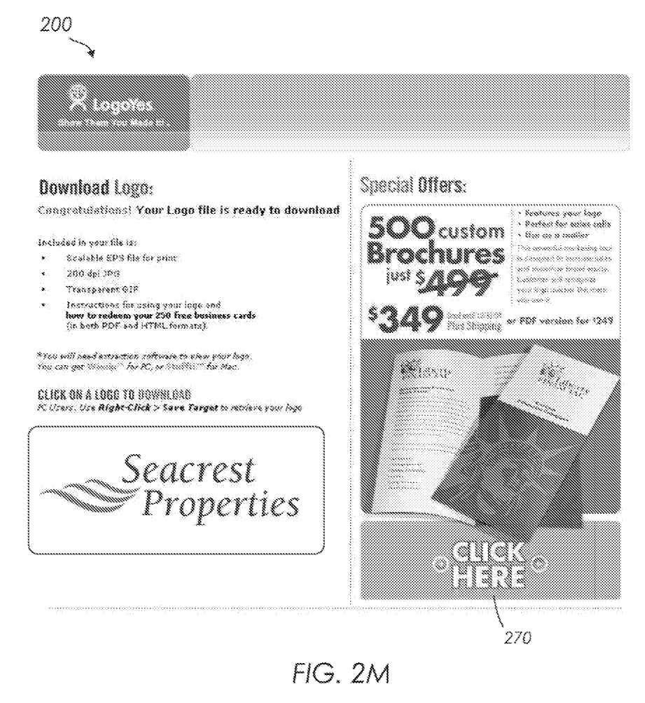

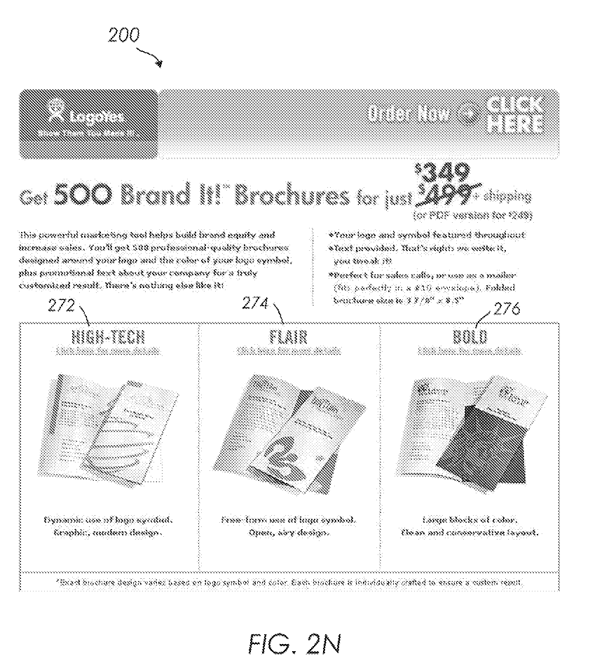

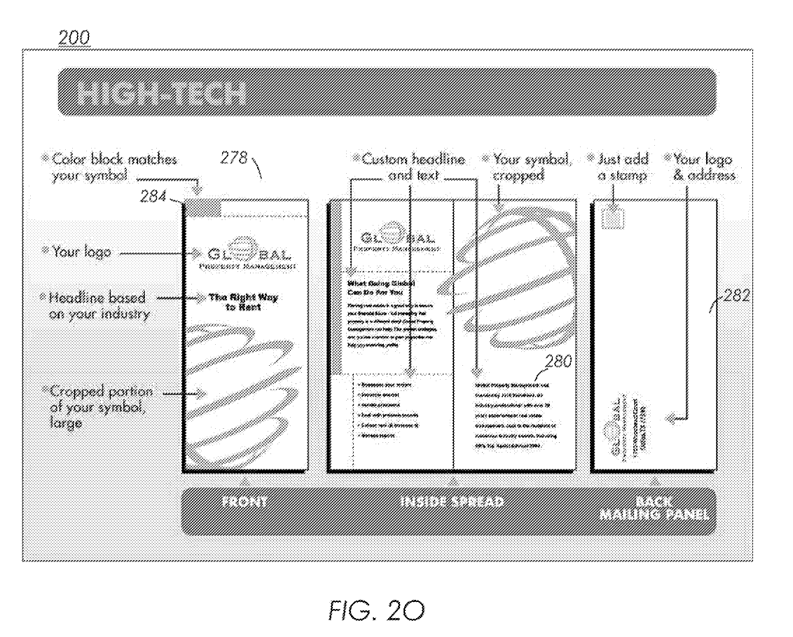

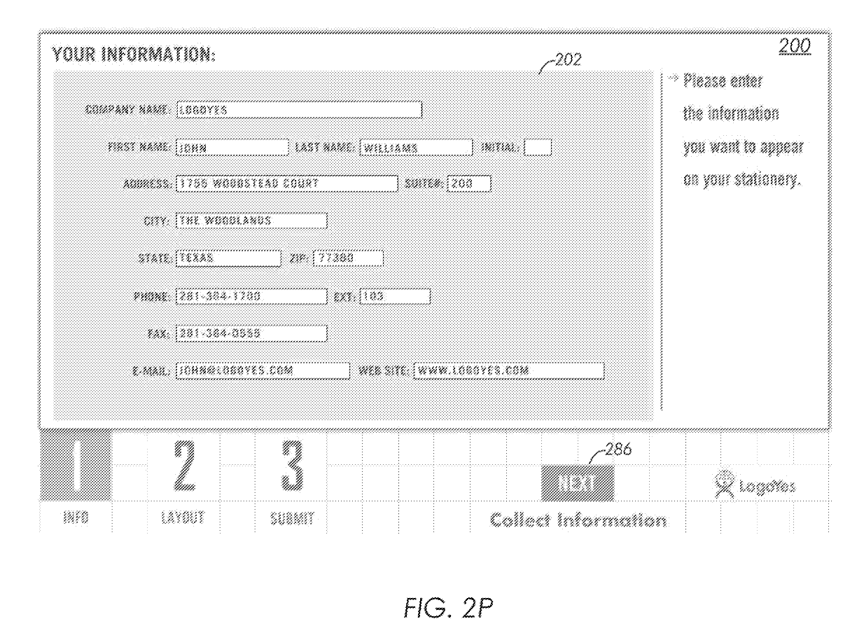

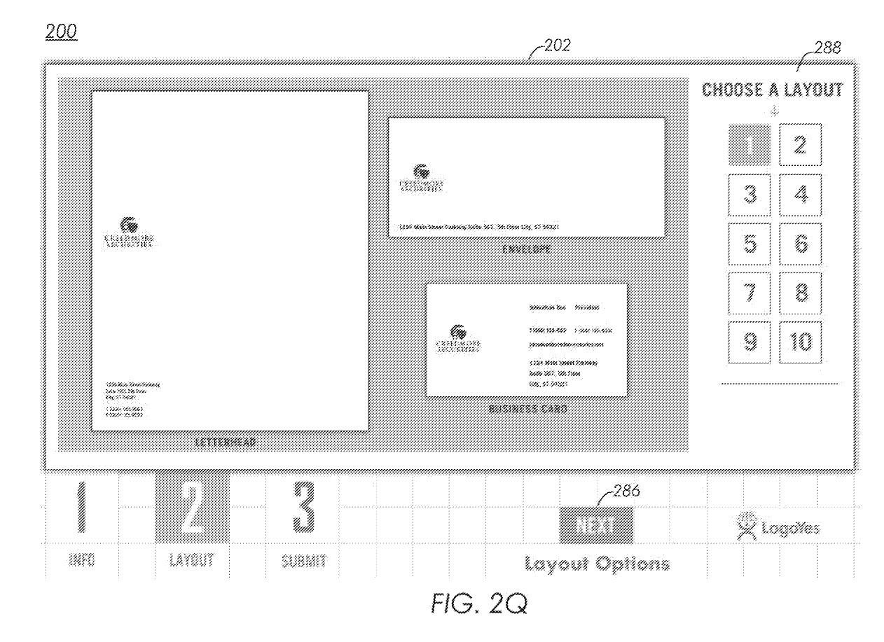

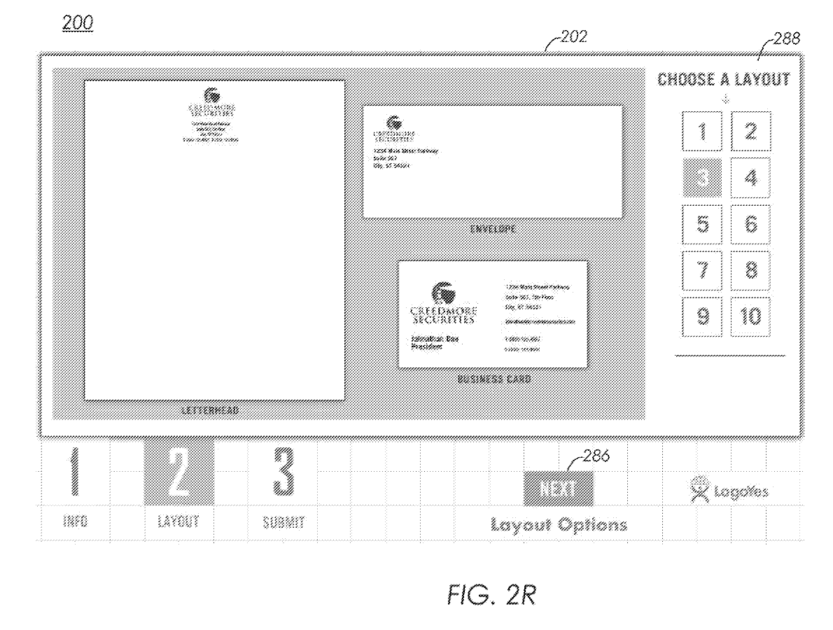

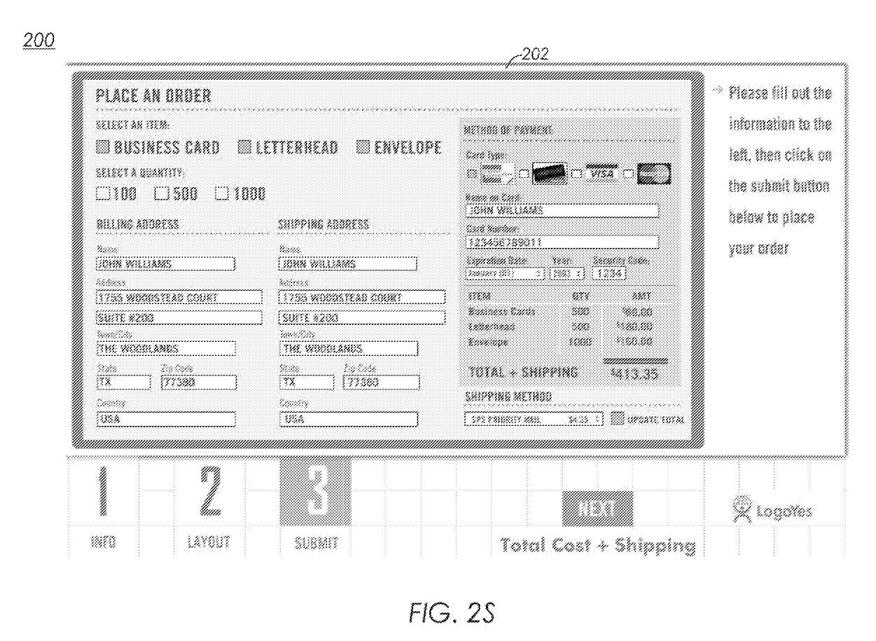

Referring to FIGS. 1 and 2A-2L, FIGS. 2A-2L depict an embodiment of a graphical user interface (UI) 200 that can be presented on a computer display device to allow the user to interact with process 100 of FIG. 1 to create a logo. An image of the logo can be presented on UI 200 for viewing by the user. An interactive information area 202 can be provided along with selectable options, shown for example as selectable options 204 through 214, to allow the user to through various phases of process 100. Selectable options 204 through 214 may be presented at any desired location on UI 200. In the embodiment shown, selectable options 204 through 214 can allow the user to access various phases of process 100 including selecting a look or image, a type of industry, or other characteristic associated with the organization 102; a symbol 104; a font or name 106; layout and color 108. Submit option 214 allows the user to submit the logo for final processing and delivery. In some implementations, one or more image files of the selected logo are delivered to the user via any suitable means and in any suitable format.

Other selectable options pertaining to the particular phase of the logo design process can also be presented on UI 200. For example, UI 200 shows selectable options 216 through 220 that allow the user to choose between different types of appearances for the logo. In the embodiment shown, selectable options 216 through 220 include High Tech, Bold, and Flair options, respectively. Other suitable selections, such as “Traditional”, “Classic”, “Contemporary”, “Modern”, “Fun”, “Playful”, “Artistic”, “Confident”, “Chic”, “Elegant”, among others, can be included in addition to, or instead of, High Tech, Bold, and Flair options 216 through 220.

If a user is not sure of the look or image to use, an image calculator option 222 can be provided to allow the user to access an interactive process that guides the user in determining an appropriate appearance or image for the logo. In some embodiments, the image calculator comprises a series of multiple choice questions which the user answers interactively. Each answer is assigned a value and, after answering all questions, the process tallies the responses and conveys a recommended look or image to the user.

When the user selects a look or image via selectable options 216-220, UI 200 can automatically or manually proceed to a subsequent phase of process 100, such as allowing the user to specify an industry or type of organization, as depicted for example in FIG. 2B. In the embodiment of UI 200 shown in FIG. 2B, interactive information area 202 includes several selectable options 224 that allow the user to choose a characteristic associated with the organization for which the logo is being designed. For example, the options can include different industry categories that can be associated with an organization. Other suitable characteristic options can be provided, such as charitable, social, public corporation, private corporation, partnership, sole proprietorship, and country of origin. In some embodiments, the user can select one or more category of image, industry, and/or any other suitable characteristic for initiating the logo design process.

In some embodiments, selecting an image, a type or industry, and/or other characteristic, can influence features such as the types of symbols, typeface fonts, and/or colors that are made available for selection by the user during subsequent phases of process 100. As an example, a user selects High Tech image option 216, and the Energy option from industry options 224. Upon automatic operation or by manually selecting option 208, a group of selectable symbols 226 is presented in information area 202. The examples shown in FIG. 2C are designed to convey a High Tech Energy image. Similarly, symbols associated with other image options 216-220 will typically be designed to convey a corresponding impression. An indicator of the number of each symbol, and the total number of symbols available for the combination of selected options 216-220 and/or 224 can also be displayed in UI 200. A page scroll feature can be included to allow the user to browse more than one page of symbols, as required.

The embodiment of UI 200 shown in FIG. 2C can also include options that allow the user to narrow the range of symbol options 226. As an example, UI 200 in FIG. 2C shows a keyword option 228 that allows the user to enter a keyword, such as “power plug” or “power grid”. FIG. 2C shows other examples of options that can be included in a configuration of UI 200, such as abstract option 228 that allows the user to search for abstract symbols; letters/numbers option 232 that allows the user to narrow the selections to numbers and/or letters; and request an object option 234 that allows the user to search one or more databases, contact customer support to request assistance, or other features that the website owner may wish to implement for option 234. Further, a selection indicator, such as a highlight color or a box around the selected symbol, can be included to show the user the symbol that is currently selected. Upon selecting the symbol, the symbol can be enlarged to show a more detailed view. A zoom option can also be implemented to allow the user to enlarge and/or reduce one or more of the symbols.

In some embodiments, symbol hierarchy and/or category logic can be implemented so that when the user clicks on a symbol, UI 200 changes to display additional symbols related to the selected symbol, such as shown for example in FIG. 2D. The set of symbols shown in the embodiment of UI 200 of FIG. 2D are different versions of the selected symbol to give the user the opportunity to choose from among many versions of the selected symbol. Indicators of the number of types of different versions of a symbol can be provided, such as indicators shown in FIG. 2D that show nine high-tech images, eighteen bold images, and thirteen flair images available for variations of the selected symbol.

The symbols shown in the embodiment of UI 200 of FIG. 2D correspond to selection of bold option 218. FIG. 2E shows an example of another set of symbols that can be presented when the user selects high-tech option 216. Similarly, other variations of symbols can be shown when—flair option 220 is selected. In some embodiments, the same and/or different versions of a symbol can be included in more than one category of search criteria, such as image, industry, or keyword.

Another selectable option (shown in FIG. 2D as ENERGY>GLOBE) can be provided to allow the user to determine the level of symbol selection they are currently on, and to navigate to upper or lower levels of symbol selection interface. For example, the user can select the term ENERGY to return to the upper level energy industry symbols shown in FIG. 2C. UI 200 of FIG. 2D can also include scroll option(s), such as the “< >” options shown, which allows the user to scroll forward or reverse through two or more pages of symbols at the level being displayed.

A further level of detail can be provided when a user selects a particular symbol from UI 200 of FIG. 2D. FIG. 2F shows examples of different versions of a selected globe symbol that can be presented to the user. Versions of the selected symbol can be presented in different colors, overlaid on a geometric shape with contrasting colors, or any other variations of the symbol available. UI 200 of FIG. 2F can also include options 228-234 that allow the user to search the symbol database according to various criteria, such as keyword, abstract symbols, letters/numbers, and to request a particular symbol by name or number. Other selectable options (shown in FIG. 2F as ENERGY>GLOBE>OPTIONS) can be provided to allow the user to determine the level of symbol selection they are currently on, and to navigate to upper or lower levels of symbol selection interface. For example, the user can select the term ENERGY to return to the upper level energy industry symbols shown in FIG. 2C. UI 200 of FIG. 2F can also include a scroll option, such as “< >”, that allows the user to scroll through two or more pages of symbols at the level being displayed.

FIG. 2G shows another example of UI 200 that presents increasing levels of detail for one or more selected symbols. For example, a user may select a symbol of a palm tree, and display 200 can present the palm tree alone; the palm tree with ocean waves; the palm tree with ocean waves and a setting sun; the palm tree with ocean waves and a setting sun with sunrays; and the palm tree with ocean waves, a setting sun with sunrays, a bird, and a box around the entire symbol. Once the level of detail is selected, symbols with the specified level of detail can automatically be presented for selection, or a designer can design a symbol and/or entire logo based on the level of detail selected by the customer. Once the level of detail is selected, the user can proceed to design the remaining elements of the logo.

FIG. 2H shows a depiction of another example of UI 200 that allows the user to enter one or more text strings in text box 236. Process 100 can include logic that associates one or more different font styles with corresponding image styles, symbols, as well as with particular types of organizations or industries. In the embodiment shown, a user can select “Suggested Font” option 238 to view the fonts that are associated with the selected image, symbol, type of organization and/or industry, or other selection criteria. The user can select a font to use on the entered text by selecting a font in display area 240. Other option 242 can be implemented to allow the user to add other font libraries to the available selections, and to view fonts that are available for the other image, organization type, industry, and/or other selection criteria options. The user can also access available fonts in display area 240 using scroll option 244 to change the fonts that are visible in display area 240. The word(s) used to show a sample of the font in display 240 can be a text string entered by the user in text box 236, a portion or all of the text string shown in information area 202 that has been selected by the user, or a default word or words.

The text string(s) 246 are typically positioned next to the selected symbol 248 in information area 202 in a default location in the selected font style(s). Process 100 can also include logic to show several variations of text string 246 in different positions and sizes relative to symbol 248, and allow the user to select one or more of the combinations. For example, text string 246 can be shown to the right, left, top, and bottom of symbol 248, as well as superimposed over symbol 248. The placement variations can be shown simultaneously or sequentially with options that allow the user to select a particular layout. The logic of process 100 can also substitute appropriately shaped symbol(s) for a consonant or vowel in text string 246 entered by the user, if desired. Other suitable layout variations can also be implemented. If the user enters more than one text string 246, each text string 246 may be individually formatted and positioned relative to one another and to symbol 248.

FIG. 2I shows an embodiment of UI 200 that includes options to allow the user to select the layout and color of text string(s) 246 and symbol 248. Logo format panel 250 can include options that allow the user to perform formatting functions such as rotate, transpose (flip), scale, resize, and change the color of text string 246 and/or symbol 248. The user can also select text string 246 or symbol 248 and move it to a different position relative to the other elements of the logo.

Color option area 252 can be provided to allow the user to select colors for symbol 248 and text string(s) 246. The colors may be the same or different for each element. A fixed grid of colors can be provided, as well as a color-mixing feature that allows the user to select different shades of color.

UI 200 can include other format options, as well as options that allow the user to save the current logo design (save option 254); to view candidate logos that were previously saved (view all option 256); and to reset the current logo design to undo all changes that were entered before the logo design was last saved (reset option 258). The colors and font may be reset, or the entire process may be reset to the image, industry, symbol, font, or layout selection stages. The user may be issued a password and/or user ID to leave the process and return at a later time.

FIG. 2J shows an embodiment of UI 200 that may be presented when the user selects view all option 256 (FIG. 2I). Thumbnail views of the saved logos can be displayed in information area 202. A scroll feature can be implemented for information area 202 if all of the saved logo designs cannot fit within information area 202. The user can select a saved logo design and choose edit option 262 or delete option 264. If the edit option 262 is chosen, UI 200 can present options that allow the user to edit the logo design, such as the embodiment of UI 200 shown in FIG. 2I. A user can also revert to a previous phase of process 100 by selecting options 204 through 210. Delete option 264 allows the user to remove the selected logo design from the user's library. Note that a selection indicator, such as a highlight color or a box can be used to provide a visual cue to the user for the logo selected to be edited or deleted.

FIG. 2K shows an embodiment of UI 200 that may be presented to allow the user to invite others to view the candidate logos from remote locations via a computerized information network such as the Internet. A separate username and password allowing limited access to process 100 can be issued to a user that allows anyone provided with the username and password to login to view the candidate logos. Typically, the viewers are given limited “read only” access to the candidate logos to prevent accidentally erasing the logo(s) or otherwise interfering with the logo design process. Other features can be included to facilitate selection and access to the candidate logo(s) such as email invitations to view, a ranking or polling feature that allows the viewers to cast their votes for the favorite logo(s) from among the candidates, and a voice, instant message, and/or chat feature that allows the viewers to discuss the logo online.

The user can also choose submit option 214 to indicate that they have completed the logo design and are ready to submit payment and/or receive delivery of the logo. FIG. 2L shows an embodiment of UI 200 that can be presented when the user selects submit option 214. Save option 266 can be presented to allow the user to save the version of the logo displayed in area 202. Submit option 268 can be presented to allow the user to indicate that the logo design is finished and ready to be downloaded. The user can be presented with options to download images of the file in various formats, such as compressed and uncompressed image, bitmap, and vector formats. Payment can be submitted before the user begins the design process, after the user completes one or more logo designs, or after votes for two or more candidate logos are received and tallied and the user selects the final logo design. Further, payment options can be presented to the user at any stage of creating the logo design(s).

Referring to FIG. 2M, an embodiment of UI 200 that can be presented after the user submits a logo is shown. UI 200 can include information about the logo file and instructions for downloading a selected logo. Additionally, UI 200 can include one or more options that allows the user to create and order other corporate identity materials such as brochures, stationery, business cards, business forms, promotional items, advertisements, websites, postcards, credit cards, bank checks, and other suitable materials. For example, the embodiment of UI 200 shown allows the user to select option 270 to create brochures.

FIG. 2N shows an embodiment of UI 200 that can be presented when the user selects option 270 (FIG. 2M). In the embodiment shown, the user can select between high-tech option 272, flair option 274, and bold option 276, depending on the desired appearance or image to be conveyed by the brochure. Note that other image options can be presented in addition to, or instead of high-tech option 272, flair option 274, and/or bold option 276. Further, in other embodiments, the image selected by the user for the logo can be used.

FIG. 2O shows an embodiment of a brochure 278 on UI 200 that can be presented when the user selects option 272. In some embodiments, more than one option for a form factor for brochure 278 can be selected, for example, different paper size and fold options can be presented for selection by the user. Options for selecting number of pages, paper type, color, weight, and other properties can also be provided. Templates of brochures 278 can be stored in a database, and the user may be presented with options to select from one or more different templates. The template can incorporate the selected logo in one or more locations on brochure 278. Additionally, all and/or a portion of the symbol associated with the user's selected logo can be positioned in one or more locations on brochure 278. Various properties of the symbol can be varied, such as size, scale, and rotation.

The template for brochure 278 can also include one or more text blocks 280 that allow the user to enter headlines, descriptions of goods and services, contact and office location information, and other types of marketing copy or information. Brochure 278 can further include a mailing panel 282 that is designed to provide space for an address, a return address, and/or postage.

Text formatting options such as font type, size, alignment, color, bold, italic, underline, among others, can be provided to allow the user to customize brochure 278. The user can also import one or more images to be included in text boxes 280 or other areas on brochure 278. Further, the template for brochure 278 can include one or more color blocks 284 to add interest and draw the reader's eye to various portions of brochure 278. Color blocks 284 can use the same color(s) as the symbol and/or the text in the logo, or the user may select different colors. Further options can be included to allow the user to change the size, shape, and location of text boxes 280 and/or color blocks 284.

In some embodiments, UI 200 can also include options that allow the user to create other corporate identity materials such as brochures, stationery, business cards, business forms, promotional items, advertisements, websites, postcards, credit cards, bank checks, and other suitable materials. FIG. 2P shows an embodiment of UI 200 that allows the user to enter information such as the user's name, company or organization name, title, address, phone and facsimile numbers, email address, website address, and other suitable information in information area 202 that can appear on the materials. Once the information is provided, the user can select NEXT option 286 to proceed to the layout process.

FIGS. 2Q and 2R show two different embodiments of UI 200 with different layout choices in information area 202. Note that any number of layout choices can be provided. The layouts typically include the selected logo, along with the additional information entered by the user in UI 200 shown in FIG. 2P. Layout option area 288 can be included to allow the user to select between pre-formatted layouts. Additionally, other options can be included to allow the user to customize a layout as part of layout option area 288, including any suitable text, image, and graphics formatting and positioning options. Different paper, envelope, and business card colors, sizes, and styles can also be presented for user selection, with the resulting appearance of the selected materials presented to the user in area 202.

Once the user is finished with the layout process, the user can select NEXT option 286 to place the order and submit the layout for printing. FIG. 2S shows an embodiment of UI 200 that allows the user to indicate desired quantities of the materials, and billing, shipment, and payment information. Note that UI 200 allows the user to return to information entry and layout stages to make any modifications before finally submitting printing order and payment. Additionally, an option can be provided that allows the user to download the layout for the selected materials in an appropriate format for use by a printer or for other purposes.

Referring again to FIG. 2A, if a user is not sure of the look or image to use, an image calculator option 222 can be provided to allow the user to access an interactive application program that guides the user in determining an appropriate appearance or image for the logo. In some embodiments, logic instructions that are executed when image calculator option 222 is selected comprises a series of questions which the user answers. Each answer is assigned a value, and after answering all questions, the image calculator then calculates the recommended look or image and conveys the recommendation to the user. Other suitable logic for determining the image can be utilized, however.

Note that some or all of the options presented via UI 200 can be implemented to be presented and/or selected via any suitable user input/output devices, such as computer display devices, a keyboard, voice input/recognition system, light pen, touch screen, and/or other suitable devices.

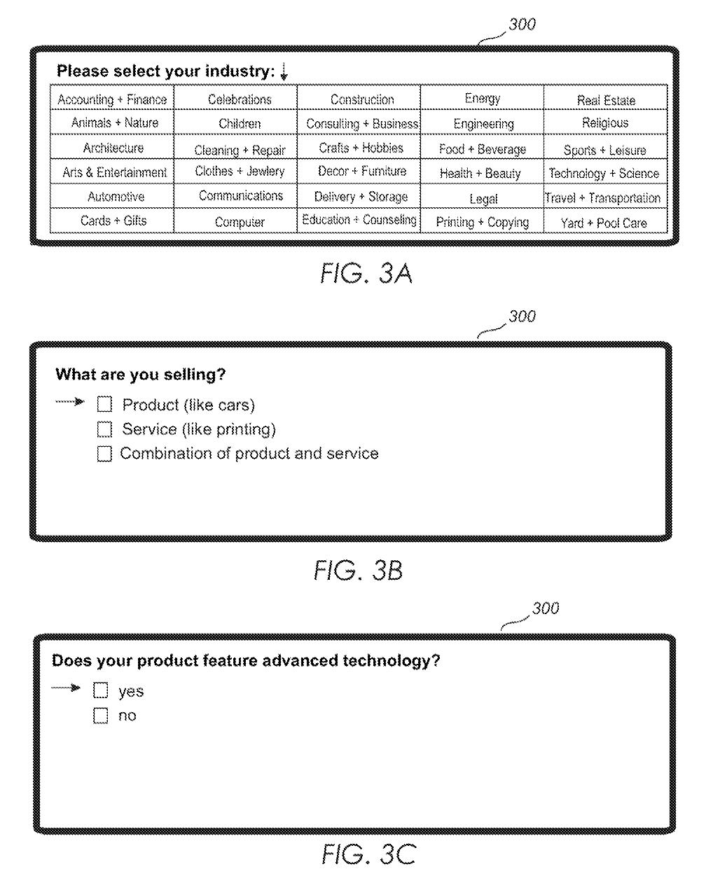

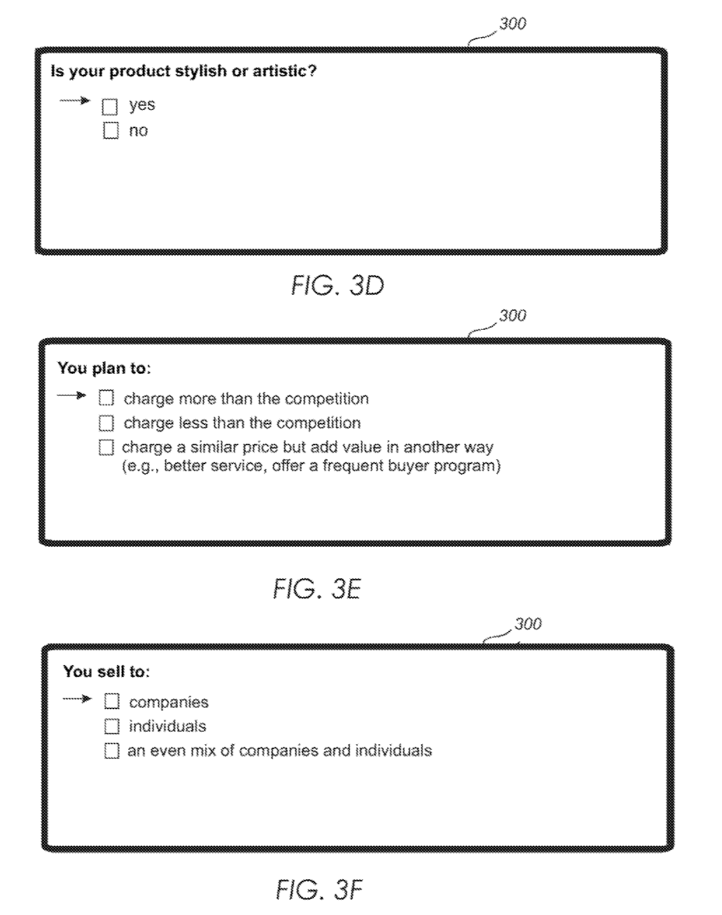

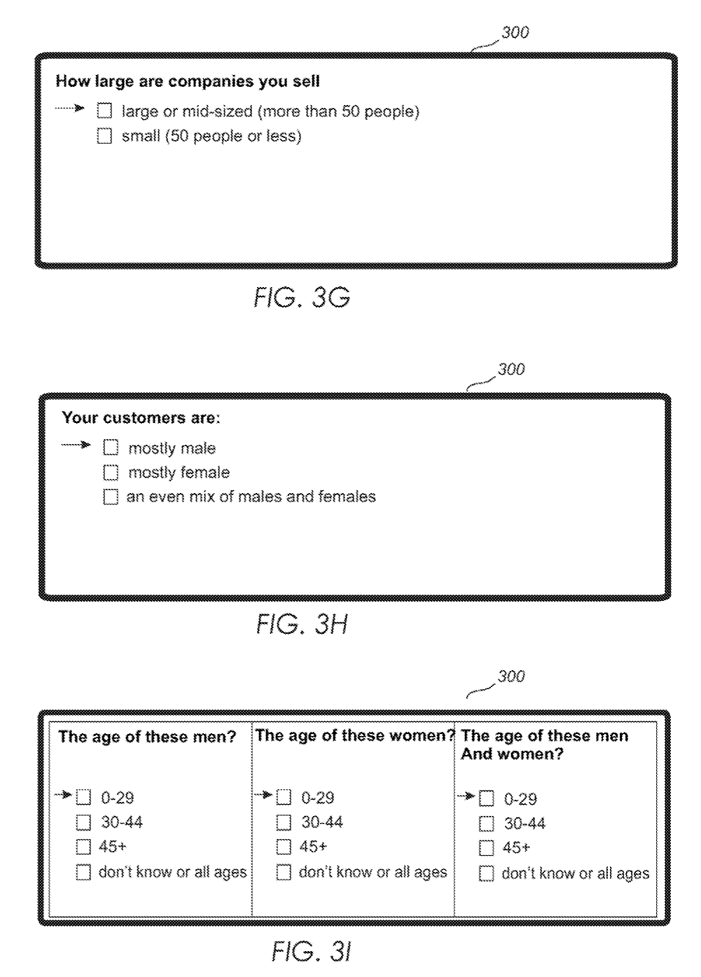

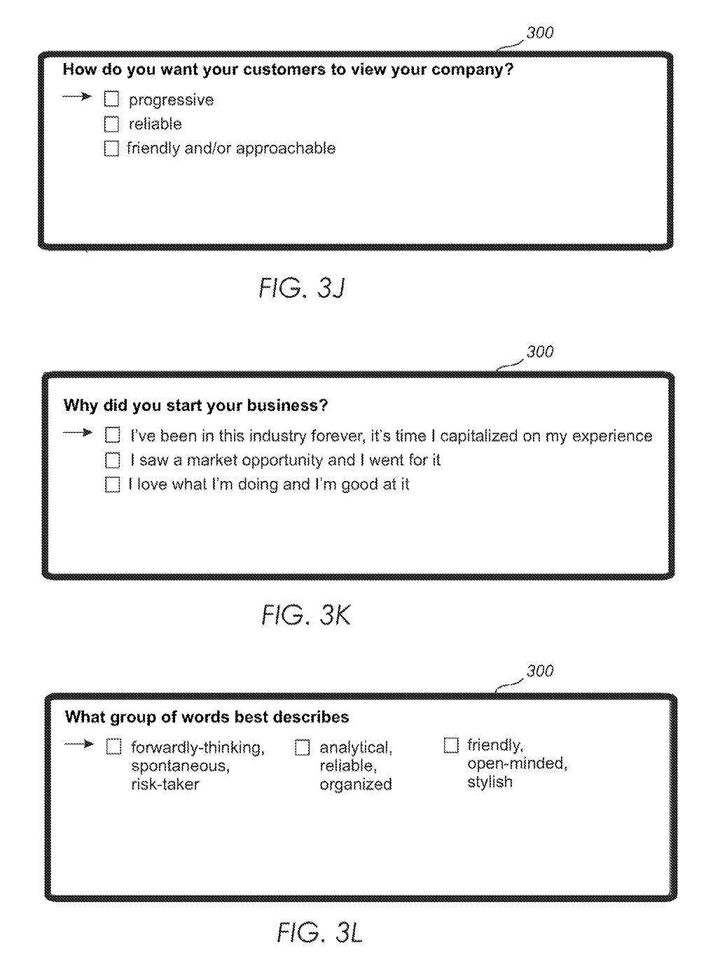

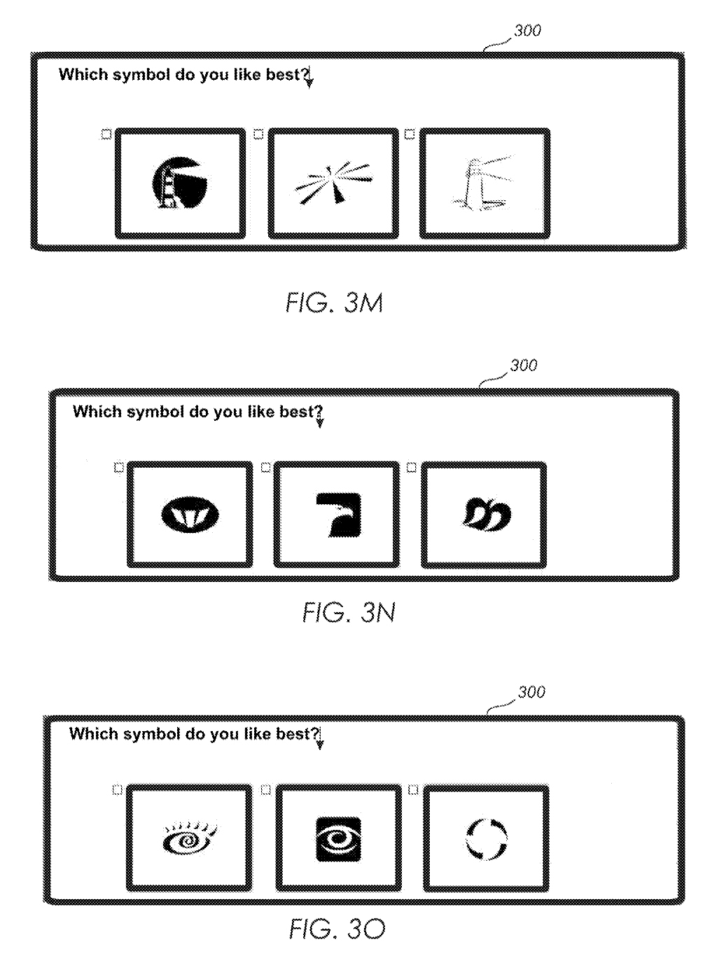

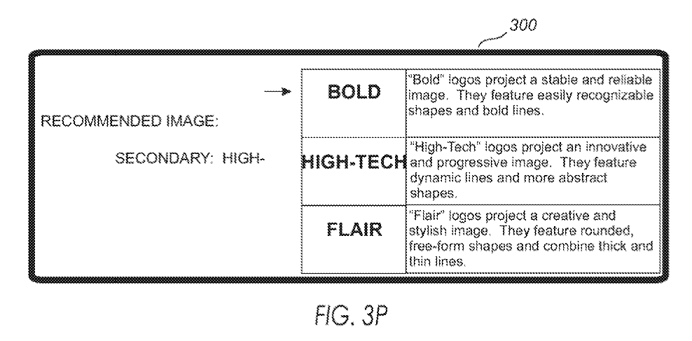

FIGS. 3A-3P show an example of a user interface (UI) 300 that can be implemented to help the user determine an image that is desired to be conveyed by the logo. In the embodiment shown in FIGS. 3A-3P, UI 300 poses a series of questions and uses the responses to the questions to recommend an appropriate image. In some embodiments, the user is asked to respond to a series of questions related to various categories such as business, personal, and perception categories. An indicator bar (not shown) can be included to allow the user to monitor progress through the image determination process. For example an indicator bar can indicate the number of questions in each category, as well as the total number of questions that will be posed to the user.

Examples of UI 300 that pose business-related questions are shown in FIGS. 3A-3J. For example, FIG. 3A allows the user to indicate the organization's industry. The choices available for selection include a) desire to capitalize on experience in a particular industry; b) seize a market opportunity; and 3) to do something the user enjoys and does well. FIG. 3B shows an example of UI 300 that allows the user to indicate whether they are selling products, services, or a combination of products or services, while another query, such as the example shown in FIG. 3C, allows the user to indicate whether the product, service, or combination of product/service features advanced technology. Additionally, the user can be queried to indicate whether the product, service, or combination of product/service is stylish or artistic, as shown in the sample query presented in FIG. 3D.

FIG. 3E shows an example of UI 300 that allows the user to indicate the pricing strategy for their company, such as charging more or less than the competition, or charging a similar price as the competition while adding value in another way. The user can also provide input regarding the organization's type of customers, such as other businesses (e.g., wholesale and business-to-business), or individuals (e.g., retail or personal services), as shown for example in FIG. 3F. Examples of other types of information that may help determine an appropriate image to be conveyed by the logo can include the size of the companies to which the user's organization sells (FIG. 3G); whether the customers are male, female, or a combination of male and female (FIG. 3H); the age of the male and/or female customers (FIG. 3I); and how the user wants customers to perceive the organization, such as progressive, reliable, or friendly/approachable (FIG. 3J). Note that other queries can be posed via UI 300 to elicit information and responses about the user's organization, in addition to, or instead of, the sample queries shown in FIGS. 3A-3J.

Examples of UI 300 that pose questions related to the user personally are shown in FIGS. 3K-3L. The questions and responses are geared to elicit information from users that determine their preferences for a particular type of image. FIG. 3K shows an example of UI 300 that allows the user to indicate one of the reasons why the user started his or her own business. FIG. 3L shows an example of UI 300 that allows the user to indicate a group of words that best describes the user. In the example shown, the first group includes forward-thinking/spontaneous/risk-taker; the second group includes analytical/reliable/organized; and the third group includes friendly/open-minded/stylish. Other questions related to the user's own characteristics can be included in addition to, or instead of, the example questions shown in FIGS. 3K-3L.

Examples of UI 300 that pose questions related to the user's perception are shown in FIGS. 3M-3O, which allow the user to indicate which logo they prefer from among three different selections. In the examples shown in FIGS. 3M-3O, one of the symbols conveys a bold style, another symbol conveys a hi-tech style, while another symbol conveys a style with artistic flair. Other characteristics can be used in addition to, or instead of, image to help determine a user's preferences for the appearance of the logo.

In some embodiments, the user's response to each question is then tallied to generate a score. Each of the possible responses is assigned a numerical value corresponding to a type of image. For example, all possible ‘bold’ responses are given a value of “1”; all possible ‘flair’ responses are given a value of “2”; and all possible “high-tech” responses are given a value of “3”. As an example, the choices can correspond to a preference for high-tech; a preference between high-tech and flair; a preference for a bold image (likes to be noticed); and a preference for a flair image. All scores within a particular range would result in a bold image being recommended; scores in another range would result in a flair image being recommended; and scores in yet another range would result in a high-tech image being recommended. FIG. 3P shows an example of UI 300 that conveys the recommended image to the user when all of the questions have been answered.

The example of an image calculator described in connection with FIGS. 3A-3P is provided for purposes of illustration. It is anticipated that other questions or techniques for determining a user's preferences for a certain type of image to be conveyed by the logo can be implemented in the methods and systems disclosed herein. Further, such a calculator can be implemented for criteria other than, or in addition to, image, such as industry, type of organization, or other criteria or characteristic.

Further, the queries presented to the user can be selected from a database based on the user's response to previous queries to help focus on relevant aspects to be considered to recommend a particular characteristic for the logo, such as the look or image to be conveyed. For example, if an organization sells primarily to other business, the gender and age of the customers may not be relevant. Similarly, if an organization's customers are primarily men, then the age of female customers would not be as relevant as the age of the male customers. Still further, the user's responses to the queries can be stored and used during the design process to automatically search for the most relevant symbols in the database.

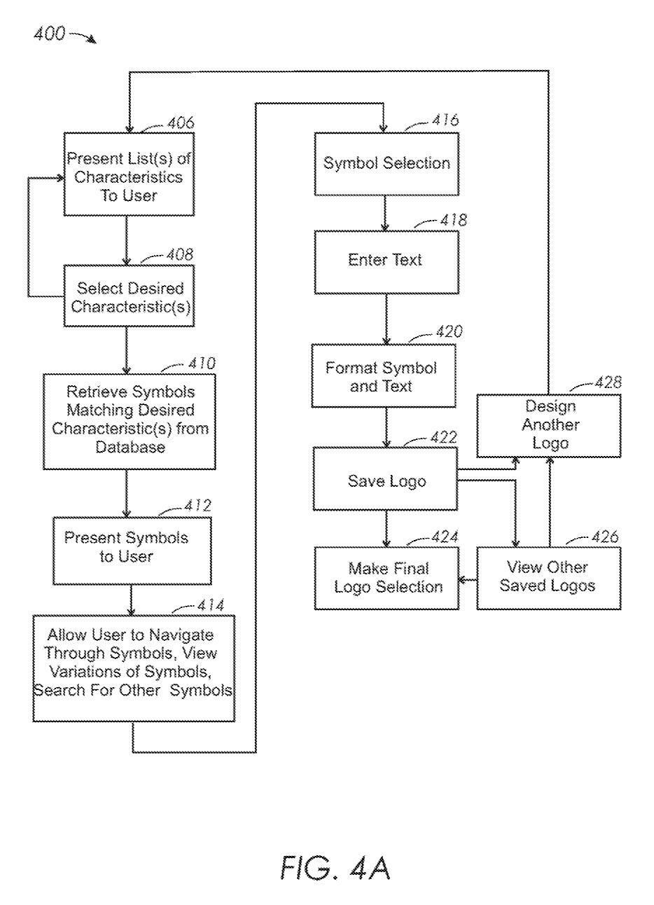

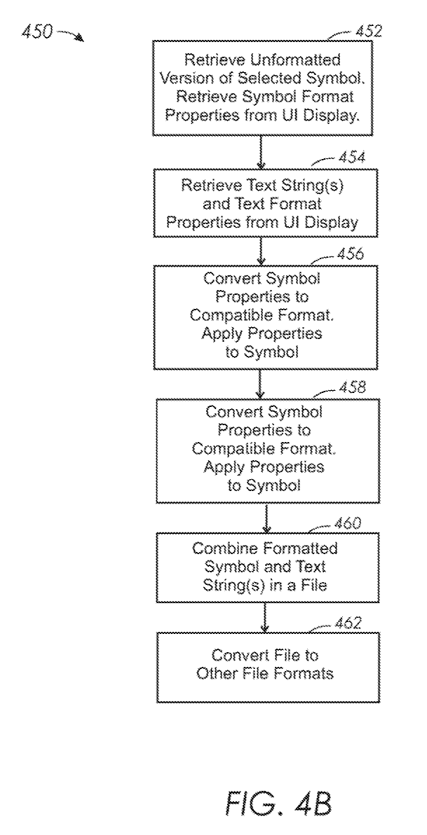

FIG. 4A represents a flow chart of an embodiment of a process 400 for designing a logo in accordance with the present invention. A user begins the logo design process by viewing a list of desired characteristics, such as a list of potentially desired images, to be conveyed by the logo at process 406. For example, potentially desired images can include High-tech, Bold, and Flair types of images. The user can select one of the characteristics in the list at process 408. When the user selects one of the characteristics in process 408, process 400 can loop back to process 406 to present another list of other potentially desired characteristics, such as the relevant industry or type of organization, to the user. The user can also be given an option to bypass selecting a characteristic from one or more of the lists. The other characteristics can be selected by looping through processes 406 and 408 until all of the lists of characteristics have been presented to the user.

Once all of the desired characteristics have been selected, a set of graphic symbols matching the selected characteristics is retrieved from a database in process 410 and presented to the user at process 412. The user can navigate through the symbols presented, enter new search criteria to retrieve additional symbols, or to narrow the set of symbols presented in process 414, and select on of the graphic symbols at process 416. If the user cannot find a symbol that is acceptable, the user may return to any of the previous processes 406-414 to change the desired characteristics for the logo and search the database of symbols again.

Once a specific symbol is selected at process 416, the user proceeds to process 418 to enter text to be included in the logo. When the text is entered, process 420 allows the user to format the symbol and/or one or more lines of text by varying parameters such as color, size, font style, layout, and position, among others. Once the logo is finished, the user may save the logo in a library at process 422, make a final selection of the logo at process 424, view other candidate logos in the user's library of saved logos at process 426, and/or elect to design another logo at process 428 and returning to process 406.

In some embodiments a logo design can include elements, such as text and symbols, in different formats. For example, in some embodiments, the text portion of the logo is displayed as a Macromedia Flash (.swf) image when the text is entered by the user. In such embodiments, the symbol can be stored in encapsulated postscript (EPS) format, for example, which is then converted to Flash format for display on UI 200. The user can change properties, such as scaling, color, position, and rotation, among others, of the symbol and the text string(s) logo elements in the Flash display. The Flash display properties for the logo elements can be used to convert the logo elements to other file formats.

Referring to FIG. 4B, an embodiment of process 450 is shown that can be used to convert logo elements in different formats to the same format before a file containing the logo is sent to the user. Process 452 can include retrieving the selected symbol from a database or other location. In some embodiments, the symbol is stored in EPS format, however, the symbol can be stored in one or more other suitable formats. Process 452 can also include retrieving the properties of the user-formatted version of the symbol from the user interface (UI) display. For example, the UI display may be formatted in Flash, and therefore the properties are in Flash format.

Process 454 can include retrieving one or more text strings entered by the user for the logo, along with related text format properties from the user interface display. The corresponding text in another format, such as vector graphics format, can be retrieved from a file or other suitable storage location. Properties such as such as font type, point size, and x-position can be also be retrieved with the text already rendered in the other format. Other properties such a color, rotation, and scale, can be retrieved from the user interface, which may be implemented in a Macromedia Flash or other suitable display format. Note that each text string may have different properties depending on the logo design. Process 454 can convert the text strings and related properties so that they are all in the same format.

Process 456 can include converting the symbol and/or the related symbol properties to the same format, and applying the properties to the symbol to configure the symbol to be combined with the text in a file. Accordingly, process 458 can include converting the text strings and/or related text properties to the same format as the symbol, and applying the text properties to the text strings. In some embodiments, the formatted symbol and text string(s) are rendered in EPS format, however, other suitable file formats can be used.

Process 460 can include writing the formatted symbol and text string(s) to the same file that can be delivered to the user as the logo file. The contents of the logo file can then be converted to other formats such as JPG (Joint Photographic Experts Group) and/or GIF (Graphics Interchange Format), among others, in process 462. Note that process 450 can also be used during the process of entering information and selecting the layout for business materials as shown in FIGS. 2M-2S and further described herein, as well as for delivering the layout information in an appropriate format for printing and/or other desired purposes such as use in word-processing documents and web sites.

While process 450 uses EPS and Flash formats as an example, the symbols can be stored in any suitable format and left in the same format, or converted to another format, to be compatible with the format for the text, and vice versa. The logo in the file can be sent to the user in any format desired. For example, the logo can be delivered in EPS format, which is typically used to create printed items such as stationery and business cards; GIF format, which is typically used for web sites; and JPG format, which is typically used in word processing documents. Note that symbols and text strings can be referred to as objects. Further, process 450 can be adapted to handle any type of objects in addition to, or instead of, symbols and text strings.

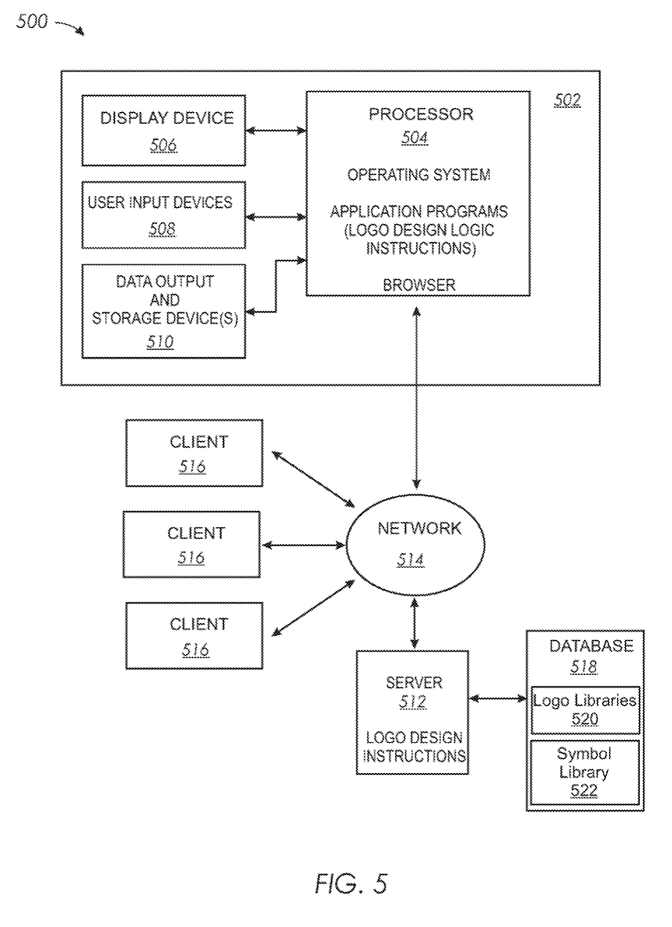

FIG. 5 shows an embodiment of processing system 500 that can be configured to allow one or more users to access logo design process 100 of FIG. 1. Processing system 500 can include one or more workstations 502 that operate in standalone and/or networked modes. In standalone mode, the logic instructions associated with logo design process 100 can be stored in memory associated directly with a particular workstation 502 and executed by a data processor 504 in workstation 502. Processor 504 typically executes other instructions such as an operating system that controls the execution of application programs, a network interface program referred to as a browser, as well as components that interface with a display device 506, user input devices 508, and data output and storage devices 510. Display device 506 is typically a video screen capable of displaying images, such as UI 200 in FIGS. 2A-2S and UI 300 in FIGS. 3A-3P, provided by processor 504. User input devices 508 can include a variety of devices such as a mouse, keyboard, light pen, touch screen, and microphone, with or without voice recognition capabilities. Data output and storage devices 510 can include a variety of devices capable of receiving information from processor 504 and outputting the information in a format that is directly usable by the user or by other components of processing system 500.

Workstation 502 can also be configured to access other workstations in a peer-to-peer configuration, as well as one or more servers 512 via network 514. In some embodiments, components in processing system 500 can communicate with one or more external or internal networks 514 via suitable interface links such as any one or combination of T1, ISDN, cable line, a wireless connection through a cellular or satellite network, or a local data transport system such as Ethernet or token ring over a local area network.

Additionally, workstations 502, server 512, and clients 516 can be embodied in any suitable computing device, and so include personal data assistants (PDAs), telephones with display areas, network appliances, desktops, laptops, X-window terminals, or other such computing devices. Clients 516 can include systems referred to as “thin clients” that access server 512 for application software, as well as “fat clients” that include more memory for storing their own versions of application software. Thus, instructions that implement logo design process 100 can reside on server 512 and accesses by clients 516. Server 512 can also interface with database 518 for storing one or more libraries 520 of saved logo designs for each user.

Database 518 can also include symbol library 522 that includes images of symbols that can be presented to users for selection, such as in UI 200 shown in FIGS. 2C-2F. A relational database tool can be used to categorize the symbols in several different ways, such as by image, by industry, subject matter, keyword, and artistic style. Each symbol can fall into one or more category and subcategories. Such an arrangement of symbols allows users to search symbol library 522 by category and subcategory on various levels. For example, a category of animals can include birds, horses, farm animals, aquatic animals and fish, dogs, cats, and bugs and insects. Each category of animal can also be sub-categorized by style such as abstract and realistic, and/or by image type. A further sub-category can include variations of a particular symbol that can be presented to the user on request. Other categories and subcategories can be implemented for the symbols. FIGS. 2C-2F can be implemented to present a cascade of symbols according the categories and subcategories selected by the user. Option selections can be presented to indicate the categories and subcategories that are available to the user, as well as an option to search symbol library 522 by keyword and/or number. Any of the selectable options can be implemented with buttons, pull-down menus, keyboard strokes, or other suitable mechanism for designating a choice or entering data.

Further database 518 can be used to store templates for brochures 278 (FIG. 2M) and other business materials and/or promotional items, such as letterhead, envelopes, and business cards, for example, as further described herein for FIGS. 2Q-2R. The ability to design a logo and other corporate identity materials in an integrated system can provide a seamless solution for small business owners, non-profit organizations, and others who desire professional-looking materials in an efficient and cost-effective manner.

Logic instructions associated with logo design processes 100, 400, 450, and generation of UIs 200, 300 in FIGS. 2A-3P can be stored and distributed on a computer readable medium including portable memory devices, accessed in the form of electronic signals, or downloaded from a network site, such as server 512. The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components have been discussed as separate and discrete components. These components may, however, be combined to form different combinations of software modules, logic modules, integrated circuits, user interface displays, or electrical assemblies, if desired. Further, one or more features shown in various embodiments of UIs 200, 300 can be combined/rearranged with features of other embodiments of UIs 200, 300.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

We claim:

1. A system for designing a logo, comprising:
computer executable instructions on computer readable media operable to:
present at least two choices of desired characteristics to be represented by the logo;
present an option to guide the user in determining the characteristic appropriate for the logo;
allow the user to select at least one of the desired characteristics;
present symbols based on the selected characteristic; and
allow the user to select at least one of the symbols to be used in the logo.

2. The system of claim 1, further comprising computer executable instructions operable to:
allow the user to select a first text font;
allow the user to enter a text string to be included with the logo;
position the text string in at least one position proximate the at least one symbol; and
allow the user to reposition the text string relative to the symbol.

3. The system of claim 1, further comprising computer executable instructions on computer readable media operable to allow a user to navigate through the symbols.

4. The system of claim 1, further comprising computer executable instructions on computer readable media operable to allow a user to select a level of detail for the selected symbol(s).

5. The system of claim 1, further comprising computer executable instructions on computer readable media operable to highlight the selected symbol against a background of non-selected symbols.

6. The system of claim 1 further comprising computer executable instructions on computer readable media operable to present formatting options to change at least one of the group of size, shape, position, orientation, and color, of at least a portion of the logo.

7. The system of claim 2, further comprising computer executable instructions on computer readable media operable to allow the user to select a second font and compare the second font to the first font in the logo.

8. The system of claim 1, further comprising computer executable instructions on computer readable media operable to allow the user to save at least two different logos, view the saved logos, and select from among the saved logos.

9. The system of claim 1, further comprising computer executable instructions on computer readable media operable to allow the user to reset the logo to an initial state after the user has modified the logo.

10. The system of claim 1 further comprising computer executable instructions on computer readable media operable to present selectable variations of at least one of the symbols.

11. The system of claim 1 further comprising computer executable instructions on computer readable media operable to search a database of symbols, wherein the symbols are categorized according to user-selectable search criteria.

12. The system of claim 1 further comprising computer executable instructions on computer readable media operable to:
present a series of questions regarding preferences toward the characteristic;
assign a value to each possible response to the questions;
score the responses to the series of questions; and
present a recommended characteristic based on the score.

13. A computer-implemented method for determining at least one appropriate characteristic for a logo, comprising:
presenting a series of questions regarding preferences toward the characteristic to a user via a computer display;
assigning a value to each possible response to the questions;
generating a score based on the user's responses to the series of questions; and
presenting a recommended characteristic based on the score.

14. The method of claim 13, wherein the characteristic pertains to the image an organization wants to project to its customers.

15. The method of claim 13, wherein the questions pertain to an organization's type of industry.

16. The method of claim 13, wherein the questions pertain to an organization's primary type of customers.

17. The method of claim 13, wherein the questions pertain to whether the products and services offered by the organization include advanced technology.

18. An apparatus comprising:
logic instruction in computer readable media operable to:
present at least two choices of desired characteristics to be represented by corporate identity materials on a computer display;
allow the user to select at least one of the desired characteristics;
present symbols based on the selected characteristic on the computer display;
allow the user to select at least one of the symbols to be used in the materials; and
allow the user to select a template for the materials, wherein the symbol selected by the user is incorporated in the template.

19. The apparatus of claim 18, further comprising logic instruction in computer readable media operable to:
allow the user to select a first text font;
allow the user to enter a text string to be included in the materials;
position the text string in a desired location; and
allow the user to reposition the text string.

20. The apparatus of claim 18, further comprising logic instruction in computer readable media operable to allow a user to navigate through the symbols.

21. The apparatus of claim 18, further comprising computer executable instructions on computer readable media operable to allow a user to select a level of detail for the selected symbol(s).

22. The apparatus of claim 18, further comprising logic instruction in computer readable media operable to combine text with a symbol selected by the user to create a logo.

23. The apparatus of claim 22, further comprising logic instruction in computer readable media operable to allow the user to enter additional information, and combine the additional information with the logo to create a brochure.

24. The apparatus of claim 23, further comprising logic instruction in computer readable media operable to generate at least one brochure template that is selectable by the user, wherein the brochure template includes at least one area where the user can enter text and/or an image that will appear on the brochure.

25. The apparatus of claim 22, further comprising logic instruction in computer readable media operable to generate at least one stationery template that is selectable by the user, wherein the stationery template includes the logo.

26. The apparatus of claim 22, further comprising logic instruction in computer readable media operable to allow the user to enter additional information, and combine the additional information with the logo to create at least one of the group of: letterhead, envelopes, business cards, and promotional items.

27. The apparatus of claim 18 further comprising logic instruction in computer readable media operable to present options to change the format of at least a portion of the materials.

28. The apparatus of claim 18, further comprising logic instruction in computer readable media operable to allow the user to save at least two different formats for the materials, view the saved materials, and select from among the saved materials.

29. The apparatus of claim 18 further comprising logic instructions in computer readable media operable to present selectable variations of at least one of the symbols, wherein the symbols are categorized according to user-selectable search criteria.

30. The apparatus of claim 18 further comprising logic instruction in computer readable media operable to:
present a series of questions regarding preferences toward the characteristic;
assign a value to each possible response to the questions;
score the responses to the series of questions; and
present a recommended characteristic based on the score.

31. The apparatus of claim 23, wherein the brochure template includes at least one color block.

32. The apparatus of claim 23, further comprising logic instruction in computer readable media operable to allow the user to change the color, size, shape, and location of a text box and/or a color block on the brochure.

33. The apparatus of claim 23, wherein the additional information includes at least one of the group of: a person's name, a company name, an organization name, a title, an address, a telephone number, a facsimile number, an email address, and a website address.

34. The apparatus of claim 18, further comprising logic instruction in computer readable media operable to allow the user to select color, size, and style for the materials.

35. The apparatus of claim 18, further comprising logic instruction in computer readable media operable to allow the user to indicate quantities of the materials desired, and billing, shipment, and payment information.

36. The apparatus of claim 35, further comprising logic instruction in computer readable media operable to allows the user to return to information entry and layout stages to make any modifications to the materials before submitting printing order information.

37. The apparatus of claim 18, further comprising logic instruction in computer readable media operable to download a layout for the materials in a selected format.

38. The apparatus of claim 18, wherein the logic instructions are embodied in a computer readable medium.

39. The apparatus of claims 18, further comprising a processor configured to execute the logic instructions.
